(19) United States
(12) Patent Application Publication
(10) Pub. No.: US 2018/0189265 A1
(43) Pub. Date: Jul. 5, 2018

(54) LEARNING ENTITY AND WORD EMBEDDINGS FOR ENTITY DISAMBIGUATION

(71) Applicant: MICROSOFT TECHNOLOGY LICENSING, LLC, Redmond, WA (US)

(72) Inventors: Zheng CHEN, Bellevue, WA (US); Jianwen ZHANG, Sammamish, WA (US)

(21) Appl. No.: 15/736,223

(22) PCT Filed: Jun. 24, 2016
(86) PCT No.: PCT/US2016/039129

§ 371 Date: Dec. 13, 2017

(30) Foreign Application Priority Data
Jun. 26, 2015 (CN) PCT/CN2015/082445
Jul. 17, 2015 (CN) 201510422856.2

(51) Int. Cl. G06F 17/27; G06N 7/00; G06N 99/00; G06F 17/18; G06N 5/02

(52) U.S. Cl. CPC G06F 17/278; G06N 7/005; G06N 5/022; G06F 17/18; G06N 99/005

(57) ABSTRACT

Technologies are described herein for learning entity and word embeddings for entity disambiguation. An example method includes pre-processing training data to generate one or more concurrence graphs of named entities, words, and document anchors extracted from the training data, defining a probabilistic model for the one or more concurrence graphs, defining an objective function based on the probabilistic model and the one or more concurrence graphs, and training at least one disambiguation model based on feature vectors generated through an optimized version of the objective function.

### BACKGROUND

Generally, it is a relatively easy task for a person to recognize a particular named entity that is named in a web article or another document, through identification of context or personal knowledge about the named entity. However, this task may be difficult for a machine to compute without a robust machine learning algorithm. Conventional machine learning algorithms, such as bag-of-words-based learning algorithms, suffer from drawbacks that reduce the accuracy in named entity identification. For example, conventional machine learning algorithms may ignore semantics of words, phrases, and/or names. The ignored semantics are a result of a one-hot approach implemented in most bag-of-words-based learning algorithms, where semantically related words are deemed equidistant to semantically unrelated words in some scenarios.

Furthermore, conventional machine learning algorithms for entity disambiguation may be computational expensive, and may be generally difficult to implement in a real-word setting. As an example, in a real-world setting, entity linking for identification of named entities may be of high practical importance. Such identification can benefit human end-user systems in that information about related topics and relevant knowledge from a large base of information is more readily accessible from a user interface. Furthermore, much more enriched information may be automatically identified through the use of a computer system. However, as conventional machine learning algorithms lack the computational efficiency to accurately identify named entities across the large base of information, conventional systems may not adequately present relevant results to users, thereby presenting more generalized results that require extensive review by a user requesting information.

### SUMMARY

The techniques discussed herein facilitate the learning of entity and word embeddings for entity disambiguation. As described herein, various methods and systems of learning entity and word embeddings are provided. As further described herein, various methods of run-time processing using a novel disambiguation model accurately identify named entities across a large base on information. Generally, embeddings include a mapping or mappings of entities and words from training data to vectors of real numbers in a low dimensional space, relative to a size of the training data (e.g., continuous vector space).

According to one example, a device for training disambiguation models in continuous vector space comprises a machine learning component deployed thereon and configured to pre-process training data to generate one or more concurrence graphs of named entities, words, and document anchors extracted from the training data, define a probabilistic model for the one or more concurrence graphs, define an objective function based on the probabilistic model and the one or more concurrence graphs, and train at least one disambiguation model based on feature vectors generated through an optimized version of the objective function.

According to another example, a machine learning system, the system comprising training data including free text and a plurality of document anchors, a pre-processing component configured to pre-process at least a portion of the training data to generate one or more concurrence graphs of named entities, words, and document anchors, and a training component configured to generate vector embeddings of entities and words based on the one or more concurrence graphs, wherein the training component is further configured to train at least one disambiguation model based on the vector embeddings.

According to yet another example, a device for training disambiguation models in continuous vector space, comprising a pre-processing component deployed thereon and configured to prepare training data for machine learning through extraction of a plurality of observations, wherein the training data comprises a corpus of text and a plurality of document anchors, generate a mapping table based on the plurality of observations of the training data, and generate one or more concurrence graphs of named entities, words, and document anchors extracted from the training data and based on the mapping table.

The above-described subject matter may also be implemented in other ways, such as a computer-controlled apparatus, a computer process, a computing system, or as an article of manufacture such as a computer-readable storage medium, for example. Although the technologies presented herein are primarily disclosed in the context of cross-language speech recognition, the concepts and technologies disclosed herein are also applicable in other forms including development of a lexicon for speakers sharing a single language or dialect. Other variations and implementations may also be applicable. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram showing aspects of an illustrative operating environment and several logical components provided by the technologies described herein;

FIG. 2 is a flowchart showing aspects of one illustrative routine for pre-processing training data, according to one implementation presented herein;

FIG. 3 is a flowchart showing aspects of one illustrative routine for training embeddings of entities and words, according to one implementation presented herein;

FIG. 4 is a flowchart showing aspects of one illustrative routine for generating features in vector space and training a disambiguation model in vector space, according to one implementation presented herein;

FIG. 5 is a flowchart showing aspects of one illustrative routine for runtime prediction and identification of named entities, according to one implementation presented herein; and

FIG. 6 is a computer architecture diagram showing an illustrative computer hardware and software architecture.

### DETAILED DESCRIPTION

The following detailed description is directed to technologies for learning entity and word embeddings for entity disambiguation in a machine learning system. The use of the technologies and concepts presented herein enable accurate recognition and identification of named entities in a large amount of data. Furthermore, in some examples, the described technologies may also increase efficiency of runtime identification of named entities. These technologies employ a disambiguation model trained in continuous vector space. Moreover, the use of the technologies and concepts presented therein are computationally less-expensive than traditional bag-of-words-based machine learning algorithms, while also being more accurate than traditional models trained on bag-of-words-based machine learning algorithms.

As an example scenario useful in understanding the technologies described herein, if a user implements or requests a search of a corpus of data for information regarding a particular named entity, it is desirable for returned results to be related to the requested named entity. The request may identify the named entity explicitly, or through context of multiple words or a phrase included in the request. For example, if a user requests a search for “Michael Jordan, AAAI Fellow,” the phrase “AAAI Fellow” includes context decipherable to determine that the “Michael Jordan” being requested is not a basketball player, but a computer scientist who is also a Fellow of the ASSOCIATION FOR THE ADVANCEMENT OF ARTIFICIAL INTELLIGENCE. Thus, it is more desirable for results related to computer science and Michael Jordan as compared to results related to basketball and Michael Jordan. This example is non-limiting of all forms of named entities, and any named entity is applicable to this disclosure.

As used herein, the phrases “named entity,” “entity,” and variants thereof, correspond to an entity having a rigid designator (e.g., a “name”) that denotes that entity in one or more possible contexts. For example, Mount Everest is a named entity having the rigid designator or name of “Mount Everest” or “Everest.” Similarly, the person Henry Ford is a person having the name “Henry Ford.” Other named entities such as a Ford Model T, the city of Sacramento, and other named entities also utilize names to refer to particular people, locations, things, and other entities. Still further, particular people, places or things may be named entities in some contexts, including contexts where a single designator denotes a well-defined set, class, or category of objects rather than a single unique object. However, generic names such as “shopping mall” or “park” may not refer to particular entities, and therefore may not be considered names of named entities.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, circuits, and other types of software and/or hardware structures that perform particular tasks or implement particular data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration as specific implementations or examples. Referring now to the drawings, aspects of a computing system and methodology for cross-language speech recognition and translation will be described in detail.

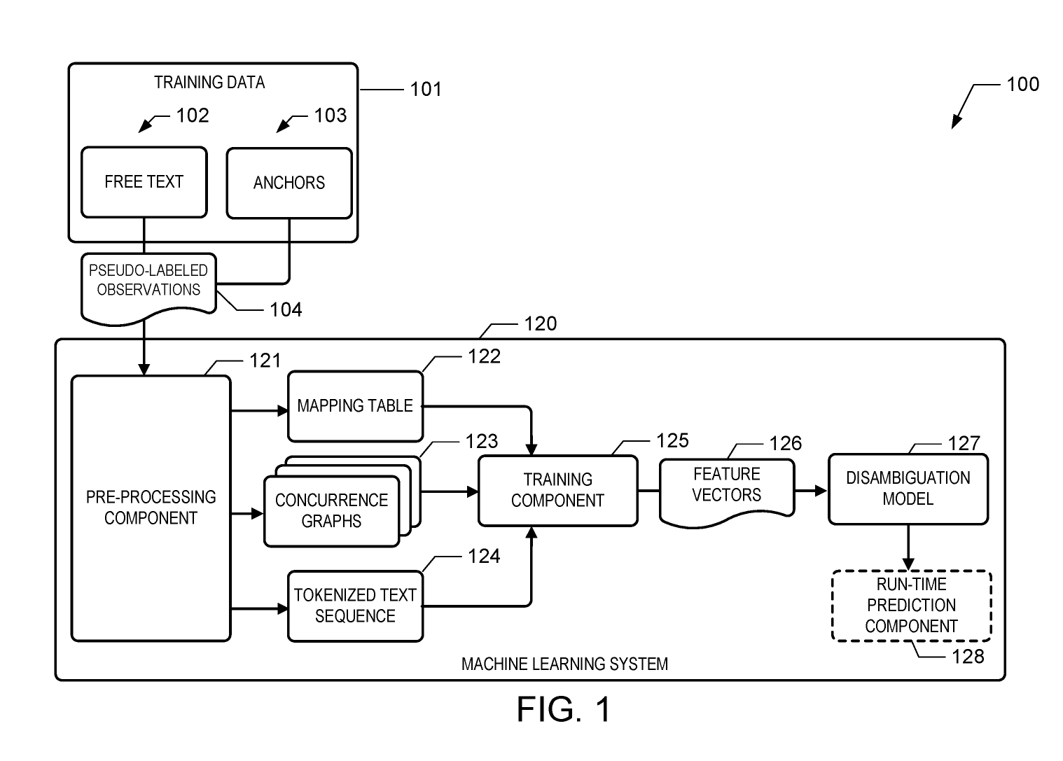

FIG. 1 illustrates an operating environment and several logical components provided by the technologies described herein. In particular, FIG. 1 is a diagram showing aspects of a system 100, for training a disambiguation model 127. As shown in the system 100, a corpus of training data 101 may include a large amount of free text 102 and a plurality of document anchors 103.

Generally, the large amount of free text 102 may include a number of articles, publications, Internet websites, or other forms of text associated with one or more topics. The one or more topics may include one or more named entities, or may be related to one or more named entities. According to one example, the large amount of free text may include a plurality of web-based articles. According to one example, the large amount of free text may include a plurality of articles from a web-based encyclopedia, such as WIKIPEDIA. Other sources for the free text 102 are also applicable.

The document anchors 103 may include metadata or information related to a particular location in a document of the free text 102, and a short description of information located near or in the particular location of the document. For example, a document anchor may refer a reader to a particular chapter in an article. Document anchors may also automatically advance a viewing pane in a web browser to a location in a web article. Additionally, document anchors may include “data anchors” if referring to data associated with other types of data, rather than particular documents. Furthermore, document anchors and data anchors may be used interchangeably under some circumstances. Other forms of anchors, including document anchors, data anchors, glossaries, outlines, table of contents, and other suitable anchors, are also applicable to the technologies described herein.

The training data 101 may be accessed by a machine learning system 120. The machine learning system 120 may include a computer apparatus, computing device, or a system of networked computing devices in some implementations. The machine learning system 120 may include more or fewer components than those particularly illustrated. Additionally, the machine learning system 120 may also be termed a machine learning component, in some implementations.

A number of pseudo-labeled observations 104 may be taken from the training data 101 by a pre-processing component 121. The pre-processing component 121 may be a component configured to execute in the machine learning system 120. The pre-processing component 121 may also be a component not directly associated with the machine learning system 120 in some implementations.

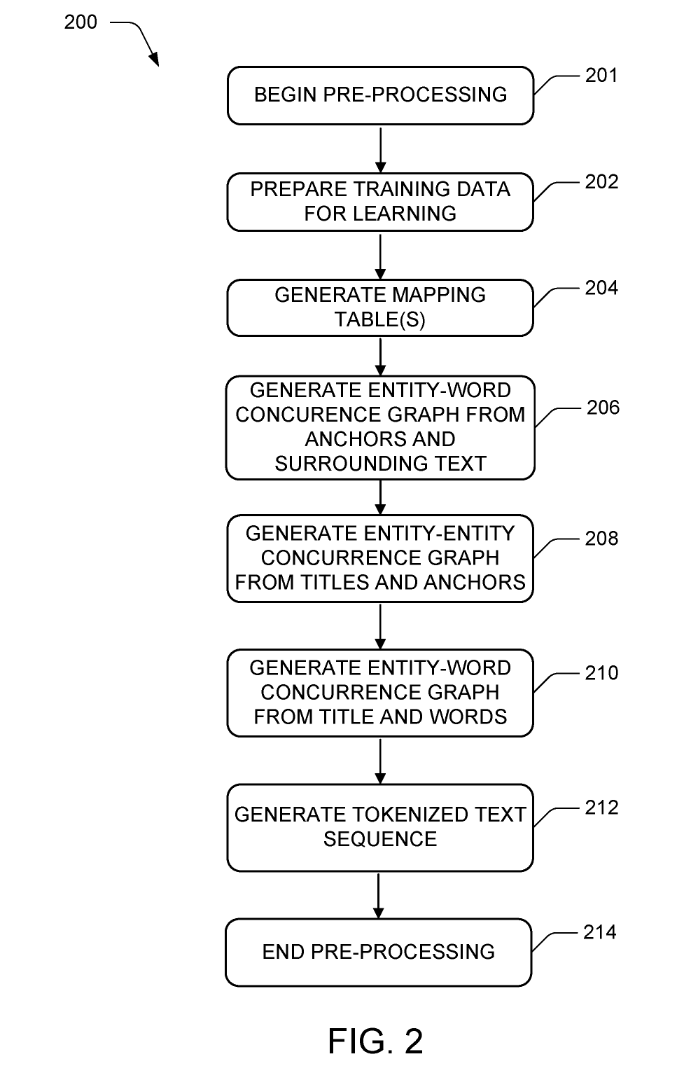

Using the pseudo-labeled observations 104, the pre-processing component 121 may generate one or more mapping tables 122, a number of concurrence graphs 123, and a tokenized text sequence 124. The pre-processing operations and generation of the mapping tables 122, concurrence graphs 123, and tokenized text sequence 124 are described more fully below with reference to FIG. 2.

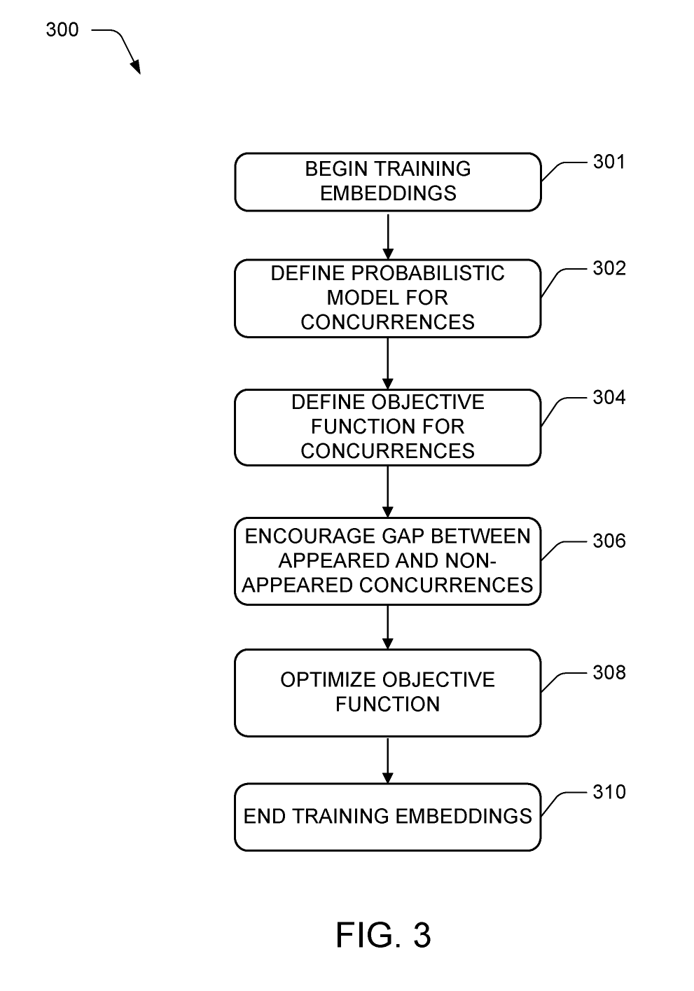

Upon pre-processing at least a portion of the training data 101 to create the mapping tables 122, concurrence graphs 123, and tokenized text sequence 124, a training component 125 may train embeddings of entities and words for development of training data. The training of embeddings of entities and words is described more fully with reference to FIG. 3.

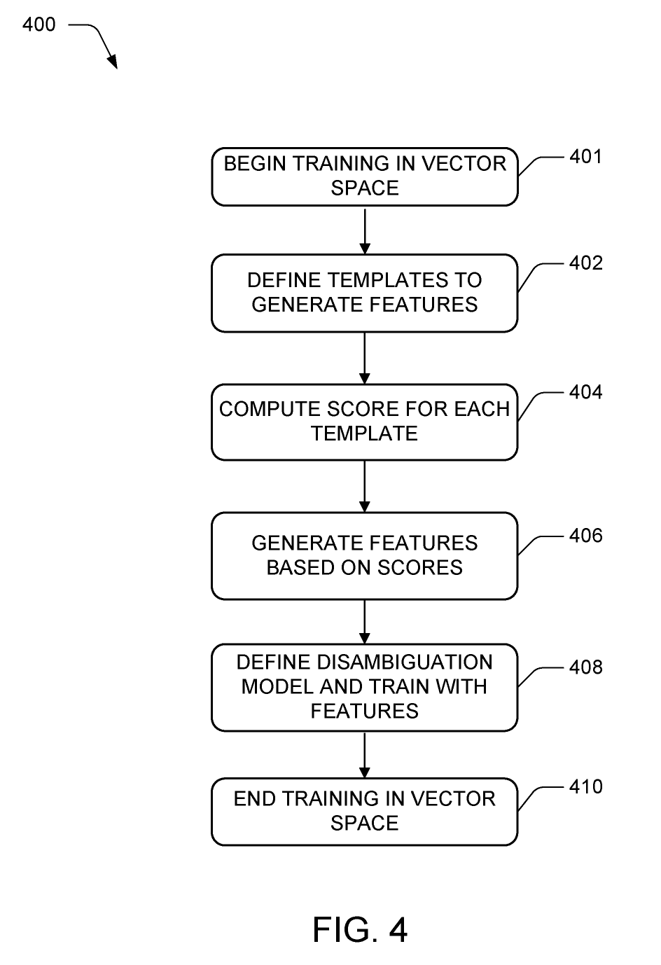

The training component 125 may also generate a number of feature vectors 126 in continuous vector space. The feature vectors 126 may be used to train the disambiguation model 127 in vector space, as well. The generation of the feature vectors 126 and training of the disambiguation model 127 are described more fully with reference to FIG. 4.

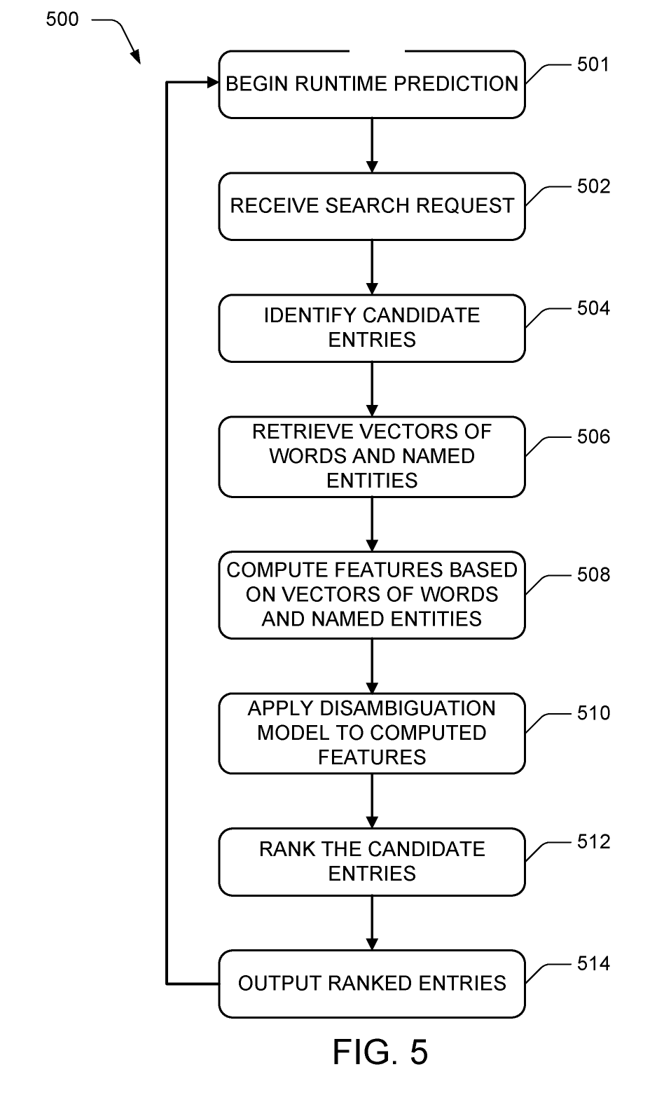

Upon training the disambiguation model 127, a run-time prediction component 128 may utilize the disambiguation model 127 to identify named entities in a corpus of data. Run-time prediction and identification of named entities is described more fully with reference to FIG. 5.

Hereinafter, a more detailed discussion of the operation of the pre-processing component 121 is provided with reference to FIG. 2. FIG. 2 is a flowchart showing aspects of one illustrative method 200 for pre-processing training data, according to one implementation presented herein. The method 200 may begin pre-processing at block 201, and cease pre-processing at block 214. Individual components of the method 200 are described below with reference to the machine learning system 120 shown in FIG. 1.

As shown in FIG. 2, the pre-processing component 121 may prepare the training data 101 for machine learning at block 202. The training data 101 may include the pseudo-labeled observations 104 retrieved from the free text 102 and the document anchors 103, as described above.

Preparation of the training data 101 can include an assumption for a vocabulary of words and entities [symbol] = [symbol] _{word} ∪ [symbol] _{entity}, where [symbol] _{word} denotes a set of words and [symbol] _{entity} denotes a set of entities. The vocabulary [symbol] is derived from the free text 102 ν₁, ν₂, . . . , νₙ, by replacing all document anchors 103 with corresponding entities. The contexts of νᵢ ∈ [symbol] are the words or entities surrounding it within an L-sized window {ν_{i-L}, . . . , νᵢ₋₁, νᵢ₊₁, . . . , ν_{i+L}}. Subsequently, a vocabulary of contexts [symbol] _{word}∪ [symbol] _{entity} can be established. In this manner, the terms in [symbol] are the same as those in [symbol] , because if term tᵢ is the context of tⱼ, then tⱼ is also the context of tᵢ. In this particular implementation, each word or entity ν∈ [symbol] , μ∈ [symbol] is associated with a vector ω_{ν}, \tilde{ω}_{μ}∈ [symbol] ^{d}, respectively.

Upon preparation of the training data 101 based on the pseudo-labeled observations 104 as described above, the pre-processing component generates the one or more mapping tables 122, at block 204. The mapping table or tables 122 include tables configured to train a model to associate a correct candidate or an incorrect candidate. Therefore, the mapping table or tables 122 may be used to train the disambiguation model 127 with both positive and negative examples for any particular phrase mentioning a candidate entity.

The pre-processing component 121 also generates an entity-word concurrence graph from the document anchors 103 and text surrounding the document anchors 103, at block 206, an entity-entity concurrence graph from titles of articles as well as the document anchors 13, at block 208, and an entity-word concurrence graph from titles of articles and words contained in the articles, at block 210. For example, a concurrence graph may also be termed a share-topic graph. A concurrence graph may be representative of a co-occurrence relationship between named entities.

As an example, the pre-processing component may construct a share-topic graph where G=(V, E) denotes the share-topic graph, where node set V contains all entities in the free text 102, with each node representing an entity. Furthermore, E is a subset of V×V, and (eᵢ, eⱼ)∈E if and only if ρ(eᵢ, eⱼ) is among the k largest elements of the set {ρ(eᵢ, eⱼ)|∈[1, |V|] and j≠i}, where ρ(eᵢ, eⱼ)=|inlinks(eᵢ)∩inlinks(eⱼ)|. Additionally, inlinks(e) denotes the set of entities that link to e.

Other concurrence graphs based on entity-entity concurrence or entity-word concurrence may also be generated as explained above, in some implementations. Upon generating the concurrence graphs, the pre-processing component 121 may generate a tokenized text sequence 124, at block 212. The tokenized text sequence 124 may be a clean sequence that represents text, or portions of text, from the free text 102 as sequences of normalized tokens. Generally, any suitable tokenizer may be implemented to create the sequence 124 without departing from the scope of this disclosure.

Upon completing any or all of the pre-processing sequences described above with reference to blocks 201-212, the method 200 may cease at block 214. As shown in FIG. 1, the training component 125 may receive the mapping table 122, concurrence graphs 123, and the tokenized text sequence 124 as input. Hereinafter, operation of the training component is described more fully with reference to FIG. 3.

FIG. 3 is a flowchart showing aspects of one illustrative method 300 for training embeddings of entities and words, according to one implementation presented herein. As shown, the method 300 may begin at block 301. The training component 125 may initially define a probabilistic model for concurrences at block 302.

The probabilistic model may be based on each concurrence graph 123 based on vector representations of named entities and words, as described in detail above. According to one example, word and entity representations are learned to discriminate the surrounding word (or entity) within a short text sequence. The connections between words and entities are created by replacing all document anchors with their referent entities. For example, a vector of ω_{ν} is trained to perform well at predicting the vector of each surrounding term \tilde{ω}_{μ} from a sliding window. As an example, a phrase may include “Michael I. Jordan is newly elected as AAAI fellow.” According to this example, the vector of “Michael I. Jordan” in the corpus-vocabulary [symbol] is trained to predict the vectors of “is”, . . . , “AAAI” and “fellow” in the context-vocabulary [symbol] . Additionally, the collection of word (or entity) and context pairs extracted from the phrases may be denoted as [symbol] .

As an example of a probabilistic model appropriate in this context, a corpus-context pair (ν, μ)∈ [symbol] , (ν∈ [symbol] , μ∈ [symbol] ) may be considered. The training component may model the conditional probability ρ(μ\ν) using a softmax function defined by Equation 1, below:

$$p ( μ \backslash v ) = \frac{exp ( {\tilde{ω}}_{μ}^{T} {ω}_{v} )}{{Σ}_{ú ∈ u} exp ( {\tilde{ω}}_{ú}^{T} {ω}_{v} )} \qquad ( Equation 1 )$$

Upon defining the objective function, the training component 125 may also define an objective function for the concurrences, at block 304. Generally, the objective function may be an objective function defined by learning as the likelihood of generating concurrences. For example, the objective function based on Equation 1, above, may be defined as set forth in Equation 2, below:

$$log σ ( {\tilde{ω}}_{μ}^{T} {ω}_{v} ) + {\sum }_{i = 1}^{c} {𝔼}_{{μ}^{′} ∼ {P}_{neg ( μ )}} [ log σ ( - {\tilde{ω}}_{μ}^{T} , {ω}_{v} ) ] \qquad ( Equation 2 )$$

In Equation 2, σ(x)=1/(1+exp(−x)) and c is the number of negative examples to be discriminated for each positive example. Given the objective function, the training component 125 may encourage a gap between appeared concurrences in the training data and candidate occurrences that have not appeared, at block 306. The training component 125 may further optimize the objective function at block 308, and the method 300 may cease at block 310.

As described above, by training embeddings of entities and words in creation of a probabilistic model and an objective function, features may be generated to train the disambiguation model 127 to better identify named entities. Hereinafter, further operational details of the training component 125 are described with reference to FIG. 4.

FIG. 4 is a flowchart showing aspects of one illustrative method 400 for generating feature vectors 126 in vector space and training the disambiguation model 127 in vector space, according to one implementation presented herein. The method 400 begins training in vector space at block 401. Generally, the training component 125 defines templates to generate features, at block 402. The templates may be defined as templates for automatically generating features.

According to one implementation, at least two templates are defined. The first template may be based on a local context score. The local context score template is a template to automatically generate features for neighboring or “neighborhood” words. The second template may be based on a topical coherence score. The topical coherence score template is a template to automatically generate features based on an average-semantic-relatedness, or the assumption that unambiguous named entities may be helpful in identifying mentions of named entities in a more ambiguous context.

Utilizing the generated templates, the training component 125 computes a score for each template, at block 404. The score computed is based on each underlying assumption for the associated template. For example, the local context template may have a score computed based on local contexts of mentions of a named entity. An example equation to compute the local context score may be implemented as Equation 3, below:

$$cs ( {m}_{i} , {e}_{i} , 𝒥 ) = \frac{1}{\vert 𝒥 \vert} {\sum }_{μ ∈ Γ} \frac{exp ( {\tilde{ω}}_{{e}_{i}}^{T} {ω}_{μ} )}{{\sum }_{{e}^{'} ∈ Γ ( {m}_{i} )} exp ( {\tilde{ω}}_{{e}^{'}}^{T} {ω}_{μ} )} \qquad ( Equation 3 )$$

In Equation 3, Γ(mᵢ) denotes the candidate entity set of mention mᵢ. Additionally, multiple local context scores may be computed by changing the context window size | [symbol] |.

With regard to a topical coherence template, a document level disambiguation context C may be computed based on Equation 4, presented below:

$$ψ ( {m}_{i} , {e}_{i} , 𝒞 ) = tc ( {m}_{i} , {e}_{i} ) = \frac{1}{\vert 𝒟 ( 𝒹 ) \vert} {\sum }_{{\hat{e}}_{i} ∈ 𝒟 ( 𝒹 )} \frac{cos ( {ω}_{{\hat{e}}_{i}} , {ω}_{{e}_{i}} )}{{\sum }_{{e}^{'} ∈ Γ ( {m}_{i} )}^{ } cos ( {ω}_{{\hat{e}}_{i}} , {ω}_{{e}^{'}} )} \qquad ( Equation 4 )$$

In Equation 4, d is an analyzed document and [symbol] (d)={ê₁, ê₂, . . . , êₘ} is the set of unambiguous entities identified in document d. After computing scores for each template, the training component 125 generates features from the templates, based on the computed scores, at block 306.

Generating the features may include, for example, generating individual features for constructing one or more feature vectors based on a number of disambiguation decisions. A function for the disambiguation decisions is defined by Equation 5, presented below:

$$\text{∀} {m}_{i} ∈ M , {argmax}_{{e}_{i} ∈ Γ ( {m}_{i} )} \frac{1}{1 + {exp}^{- {\sum }_{j = 1}^{\vert F \vert} {β}_{i} \cdot {f}_{j}}} \qquad ( Equation 5 )$$

In Equation 5, F=Uⱼ₌₁ fᵢ denotes the feature vector, while the basic features are local context scores cs(mᵢ, eᵢ, [symbol] ) and topical coherence scores tc(mᵢ, eᵢ). Furthermore, additional features can also be combined utilizing Equation 5. But generally, the training component is configured to optimize the parameters β, such that the correct entity has a higher score over irrelevant entities. During optimization of the parameters β, the training component 125 defines the disambiguation model 127 and trains the disambiguation model 127 based on the feature vectors 126, at block 408. The method 400 ceases at block 410.

As described above, the disambiguation model 127 may be used to more accurately predict the occurrence of a particular named entity. Hereinafter, runtime prediction of named entities is described more fully with reference to FIG. 5.

FIG. 5 is a flowchart showing aspects of one illustrative method 500 for runtime prediction and identification of named entities, according to one implementation presented herein. Run-time prediction begins at block 501, and may be performed by run-time prediction component 128, or may be performed by another portion of the system 100.

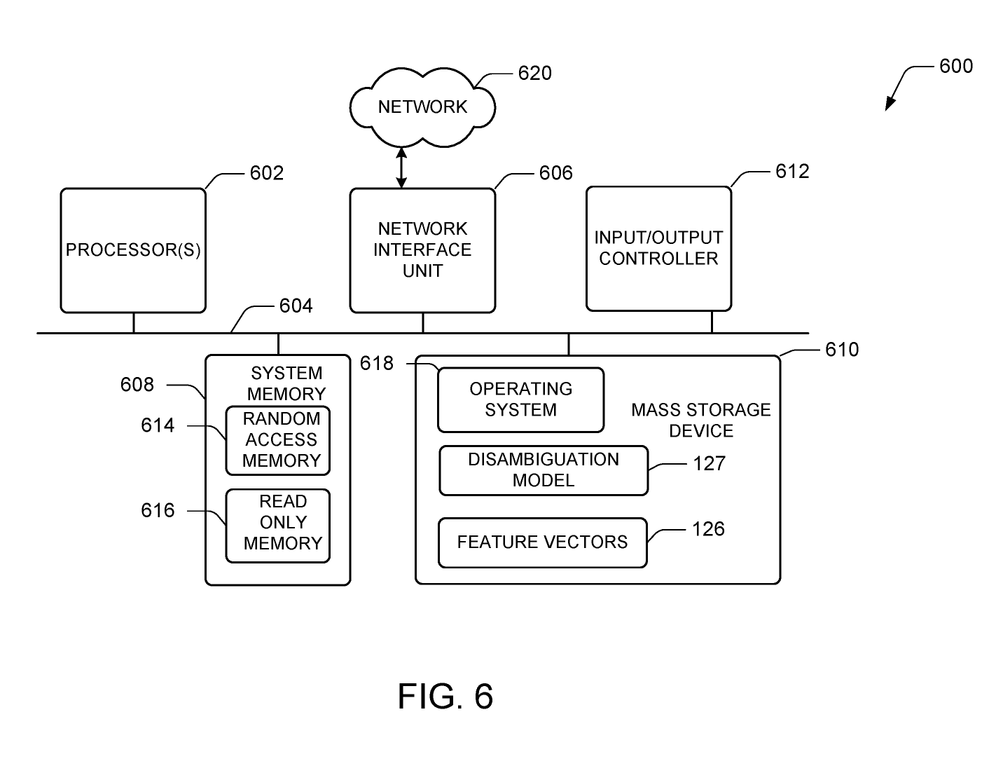

Initially, run-time prediction component 128 receives a search request identifying one or more named entities, at block 502. The search request may originate at a client computing device, such as through a Web browser on a computer, or from any other suitable device. Example computing devices are described in detail with reference to FIG. 6.

Upon receipt of the search request, the run-time prediction component 128 may identify candidate entries of web articles or other sources of information, at block 504. According to one implementation, the candidate entries are identified from a database or a server. According to another implementation, the candidate entries are identified from the Internet.

Thereafter, the run-time prediction component 128 may retrieve feature vectors 126 of words and/or named entities, at block 506. For example, the feature vectors 126 may be stored in memory, in a computer readable storage medium, or may be stored in any suitable manner. The feature vectors 126 may be accessible by the run-time prediction component 126 for run-time prediction and other operations.

Upon retrieval, the run-time prediction component 128 may compute features based on the retrieved vectors of words and named entities contained in the request, at block 508. Feature computation may be similar to the computations described above with reference to the disambiguation model 127 and Equation 5. The words and named entities may be extracted from the request.

Thereafter, the run-time prediction component 128 applies the disambiguation model to the computed features, at block 510. Upon application of the disambiguation model, the run-time prediction component 128 may rank the candidate entries based on the output of the disambiguation model, at block 512. The ranking may include ranking the candidate entries based on a set of probabilities that any one candidate entry is more likely to reference the named entity than other candidate entries. Other forms of ranking may also be applicable. Upon ranking, the run-time prediction component 128 may output the ranked entries at block 514. The method 500 may continually iterate as new requests are received, or alternatively, may cease after outputting the ranked entries.

It should be appreciated that the logical operations described above with reference to FIGS. 2-5 may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

FIG. 6 shows an illustrative computer architecture for a computer 600 capable of executing the software components and methods described herein for pre-processing, training, and runtime prediction in the manner presented above. The computer architecture shown in FIG. 6 illustrates a conventional desktop, laptop, or server computer and may be utilized to execute any aspects of the software components presented herein described as executing in the system 100 or any components in communication therewith.

The computer architecture shown in FIG. 6 includes one or more processors 602, a system memory 608, including a random access memory 614 (RAM) and a read-only memory (ROM) 616, and a system bus 604 that couples the memory to the processor(s) 602. The processor(s) 602 can include a central processing unit (CPU) or other suitable computer processors. A basic input/output system containing the basic routines that help to transfer information between elements within the computer 600, such as during startup, is stored in the ROM 616. The computer 600 further includes a mass storage device 610 for storing an operating system 618, application programs, and other program modules, which are described in greater detail herein.

The mass storage device 610 is connected to the processor(s) 602 through a mass storage controller (not shown) connected to the bus 604. The mass storage device 610 is an example of computer-readable media for the computer 600. Although the description of computer-readable media contained herein refers to a mass storage device 600, such as a hard disk, compact disk read-only-memory (CD-ROM) drive, solid state memory (e.g., flash drive), it should be appreciated by those skilled in the art that computer-readable media can be any available computer storage media or communication media that can be accessed by the computer 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of communication media.

By way of example, and not limitation, computer storage media includes volatile and non-volatile, removable and non-removable media implemented in any method or technology for storage of information such as computer-readable instructions, data structures, program modules or other data. For example, computer storage media includes, but is not limited to, RAM, ROM, erasable programmable read-only memory (EPROM), electrically erasable programmable read-only memory (EEPROM), flash memory or other solid state memory technology, CD-ROM, digital versatile disks (DVD), High Definition DVD (HD-DVD), BLU-RAY, or other optical storage, magnetic cassettes, magnetic tape, magnetic disk storage or other magnetic storage devices, or any other medium that can be used to store the desired information and which can be accessed by the computer 600. As used herein, the phrase “computer storage media,” and variations thereof, does not include waves or signals per se and/or communication media.

According to various implementations, the computer 600 may operate in a networked environment using logical connections to remote computers through a network such as the network 620. The computer 600 may connect to the network 620 through a network interface unit 606 connected to the bus 604. The network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system 618 suitable for controlling the operation of a networked desktop, laptop, or server computer. The mass storage device 610 and RAM 814 may also store one or more program modules or other data, such as the disambiguation model 127, the feature vectors 126, or any other data described above. The mass storage device 610 and the RAM 614 may also store other types of program modules, services, and data.

### EXAMPLE CLAUSES

A. A device for training disambiguation models in continuous vector space, comprising a machine learning component deployed thereon and configured to:

pre-process training data to generate one or more concurrence graphs of named entities, words, and document anchors extracted from the training data;

define a probabilistic model for the one or more concurrence graphs;

define an objective function based on the probabilistic model and the one or more concurrence graphs; and

train at least one disambiguation model based on feature vectors generated through an optimized version of the objective function.

B. A device as recited in clause 1, wherein the probabilistic model is based on a softmax function or normalized exponential function.

C. A device as recited in either of clauses A and B, wherein the softmax function includes a conditional probability of a vector of named entities concurring with a vector of words.

D. A device as recited in any of clauses A-C, wherein the objective function is a function of a number of negative examples included in the pre-processed training data.

E. A device as recited in any of clauses A-D, wherein the optimized version of the objective function is optimized to encourage a gap between concurrences defined in the concurrence graphs.

F. A machine learning system, the system comprising:

training data including free text and a plurality of document anchors;

a pre-processing component configured to pre-process at least a portion of the training data to generate one or more concurrence graphs of named entities, associated data, and data anchors; and

a training component configured to generate vector embeddings of entities and words based on the one or more concurrence graphs, wherein the training component is further configured to train at least one disambiguation model based on the vector embeddings.

G. A system as recited in clause F, further comprising a run-time prediction component configured to identify candidate entries using the at least one disambiguation model.

H. A system as recited in either of clauses F and G, further comprising:

a database or server storing a plurality of entries; and

a run-time prediction component configured to identify candidate entries from the plurality of entries using the at least one disambiguation model, and to rank the identified candidate entries using the at least one disambiguation model.

I. A system as recited in any of clauses F-H, wherein the training component is further configured to:

define a probabilistic model for the one or more concurrence graphs; and

define an objective function based on the probabilistic model and the one or more concurrence graphs, wherein the vector embeddings are created based on the probabilistic model and an optimized version of the objective function.

J. A system as recited in any of clauses F-I, wherein:

the probabilistic model is based on a softmax function or normalized exponential function; and

the objective function is a function of a number of negative examples included in the training data.

K. A device for training disambiguation models in continuous vector space, comprising a pre-processing component deployed thereon and configured to:

prepare training data for machine learning through extraction of a plurality of observations, wherein the training data comprises a corpus of text and a plurality of document anchors;

generate a mapping table based on the plurality of observations of the training data; and

generate one or more concurrence graphs of named entities, words, and document anchors extracted from the training data and based on the mapping table.

L. A device as recited in clause K, further comprising a machine learning component deployed thereon and configured to:

define a probabilistic model for the one or more concurrence graphs;

define an objective function based on the probabilistic model and the one or more concurrence graphs; and

train at least one disambiguation model based on feature vectors generated through an optimized version of the objective function.

M. A device as recited in either of clauses K and L, wherein the probabilistic model is based on a softmax function or normalized exponential function.

N. A device as recited in any of clauses K-M, wherein the softmax function includes a conditional probability of a vector of named entities concurring with a vector of words.

O. A device as recited in any of clauses K-N, wherein the objective function is a function of a number of negative examples included in the pre-processed training data.

P. A device as recited in any of clauses K-O, wherein the optimized version of the objective function is optimized to encourage a gap between concurrences defined in the concurrence graphs.

Q. A device as recited in any of clauses K-P, wherein the pre-processing component is further configured to generate a clean tokenized text sequence from the plurality of observations.

R. A device as recited in any of clauses K-Q, further comprising a run-time prediction component configured to identify candidate entries using the at least one disambiguation model.

S. A device as recited in any of clauses K-R, wherein the device is in operative communication with a database or server storing a plurality of entries, the device further comprising:

a run-time prediction component configured to identify candidate entries from the plurality of entries using the at least one disambiguation model, and to rank the identified candidate entries using the at least one disambiguation model.

T. A device as recited in any of clauses K-S, wherein the run-time prediction component is further configured to:

receive a search request identifying a desired named entity;

identify the candidate entries based on the search request;

retrieve vectors of words and named entities related to the search request;

compute features based on the vectors of words and named entities;

apply the at least one disambiguation model to the computed features; and

rank the candidate entries based on the application of the at least one disambiguation model.

### CONCLUSION

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

All of the methods and processes described above may be embodied in, and fully or partially automated via, software code modules executed by one or more general purpose computers or processors. The code modules may be stored in any type of computer-readable storage medium or other computer storage device. Some or all of the methods may additionally or alternatively be embodied in specialized computer hardware.

Conditional language such as, among others, “can,” “could,” or “may,” unless specifically stated otherwise, means that certain examples include, while other examples do not include, certain features, elements and/or steps. Thus, such conditional language does not imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrases “and/or” and “at least one of X, Y or Z,” unless specifically stated otherwise, mean that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure and protected by the following claims.

1. A device for training disambiguation models in continuous vector space, comprising a machine learning component deployed thereon and configured to:
pre-process training data to generate one or more concurrence graphs of named entities, words, and document anchors extracted from the training data;
define a probabilistic model for the one or more concurrence graphs;
define an objective function based on the probabilistic model and the one or more concurrence graphs; and
train at least one disambiguation model based on feature vectors generated through an optimized version of the objective function.

2. The device of claim 1, wherein the probabilistic model is based on a softmax function or normalized exponential function.

3. The device of claim 2, wherein the softmax function includes a conditional probability of a vector of named entities concurring with a vector of words.

4. The device of claim 1, wherein the objective function is a function of a number of negative examples included in the pre-processed training data.

5. The device of claim 1, wherein the optimized version of the objective function is optimized to encourage a gap between concurrences defined in the concurrence graphs.

6. A machine learning system, the system comprising:
training data including free text and a plurality of document anchors;
a pre-processing component configured to pre-process at least a portion of the training data to generate one or more concurrence graphs of named entities, associated data, and data anchors; and
a training component configured to generate vector embeddings of entities and words based on the one or more concurrence graphs, wherein the training component is further configured to train at least one disambiguation model based on the vector embeddings.

7. The machine learning system of claim 6, further comprising a run-time prediction component configured to identify candidate entries using the at least one disambiguation model.

8. The machine learning system of claim 6, further comprising:
a database or server storing a plurality of entries; and
a run-time prediction component configured to identify candidate entries from the plurality of entries using the at least one disambiguation model, and to rank the identified candidate entries using the at least one disambiguation model.

9. The machine learning system of claim 6, wherein the training component is further configured to:
define a probabilistic model for the one or more concurrence graphs; and
define an objective function based on the probabilistic model and the one or more concurrence graphs, wherein the vector embeddings are created based on the probabilistic model and an optimized version of the objective function.

10. The machine learning system of claim 9, wherein:
the probabilistic model is based on a softmax function or normalized exponential function; and
the objective function is a function of a number of negative examples included in the training data.
